(19) United States
(12) Patent Application Publication
(10) Pub. No.: US 2019/0379090 A1
(43) Pub. Date: Dec. 12, 2019

(54) ON-VEHICLE ALGORITHMS TO DETERMINE IF LITHIUM PLATING HAS OCCURRED

(71) Applicant: GM GLOBAL TECHNOLOGY OPERATIONS LLC, Detroit, MI (US)

(72) Inventors: Mark W. Verbrugge, Troy, MI (US); Charles W. Wampler, Birmingham, MI (US); Daniel R. Baker, Romeo, MI (US); Raghunathan K, Troy, MI (US); Brian J. Koch, Berkley, MI (US); Alfred Zhang, Troy, MI (US)

(21) Appl. No.: 16/005,842

(22) Filed: Jun. 12, 2018

(51) Int. Cl. H01M 10/48; H01M 10/42; H01M 4/133; H01M 10/0525

(52) U.S. Cl. CPC H01M 10/48; H01M 10/425; H01M 2220/20; H01M 10/0525; H01M 2010/4271; H01M 4/133

(57) ABSTRACT

During the charging of lithium-ion batteries, comprising graphite anode particles, the goal is to intercalate lithium into the anode materials as LiC₆. But it is possible to conduct the charging process at a rate that lithium is undesirably plated, undetected, as lithium metal on the particles of graphite. During an open-circuit period of battery operation, immediately following such a charging period, the presence of lithium plating can be detected, using a computer-based monitoring system, by continually measuring the cell potential (Vcell) over a brief period of open-circuit time, fitting the open-circuit voltage data to a best cubic polynomial fit, and then determining dVcell/dt (mV/s) from the polynomial fit over a like period of time. It is found that the presence of a maximum or a minimum in the derivative curve (a local minimum) reliably correlates with plated lithium on the graphite particles of the anode.

### INTRODUCTION

Lithium-based batteries are finding increasing usage in powering electric motors and other devices in automobiles and in powering other consumer devices. High energy-capacity lithium-ion batteries are required for use in powering electric motors for driving the wheels of an automobile, and in many such applications a multi-cell, high voltage, lithium-ion battery is used. The use of such batteries in such applications requires that the electrochemical cells of the battery are continually discharged and re-charged.

During discharge of a lithium ion battery, lithium ions are removed (de-intercalated) from the anode material and released into a contacting electrolyte. Electrons are simultaneously released into an anode current collector and then into an external power-requiring circuit, like an electric motor powering a vehicle. With the release of electrons, the anode is negatively charged. The lithium ions are conducted through the electrolyte, often a non-aqueous liquid solution of a lithium salt, to the cathode (the positive electrode during cell discharge). Electrons, entering the cathode from the external circuit, facilitate the intercalation of lithium into the material of the cathode. The flow of lithium ions is reversed when the electrochemical cells in the battery are being re-charged by imposing a cell potential that drives reduction at the anode and oxidation at the cathode. Electrons are forced to flow from the cathode to the anode. The composition of each electrode material must accommodate the transport of lithium into and out of the respective electrode materials (intercalation/de-intercalation). The continued capacity of each cell, during a large number of repeated charge-discharge cycles, depends in substantial measure on the effective movement of lithium into and out of the materials, often particulate materials, of the opposing electrodes.

In lithium battery materials used in powering electric motors driving automobiles, for example, graphite particles are often used in the formation of anodes. There is interest in the rate at which the graphite anode material of each cell (the negative electrode during cell discharge) can be recharged so that the battery can continue its function in the powering the vehicle and devices on the vehicle. There remains a need for improvement of the effective re-charging of the anode materials in lithium ion batteries used in automobile and in like applications in which the cells of the battery are repeatedly being discharged and re-charged.

### SUMMARY

An understanding of the practice of the subject invention is based on careful attention being given as to how the anode material is affected as lithium is re-intercalated into it during charging of the lithium-ion electrochemical cell.

By way of non-limiting example and illustration, many lithium-ion battery cells are composed of small particles of graphite as the anode material, small particles of lithium nickel manganese cobalt oxide (LiNiMnCoO₂) as the cathode material, and LiPF₆ (often 1 M), dissolved in a mixture of non-aqueous solvents, as a liquid electrolyte that permeates and contacts the surfaces of the particulate electrode materials and of a thin porous polymeric separator inserted between them. The graphite anode particles, sometimes mixed with electrically conductive carbon particles, are often resin-bonded in a porous layer of uniform thickness to both major sides of a copper foil current collector. The lithium nickel manganese cobalt oxide particles, optionally mixed with smaller conductive carbon particles, are resin-bonded in a porous layer of uniform thickness to both major surfaces of an aluminum current collector foil. The electrodes are often formed as like-sized rectangles, upstanding in an alternating assembly, with an uncoated tab or tabs at their top sides for electrical connection to other electrodes in a cell package. The anode tabs and the cathode tabs may be separately joined to a common anode and cathode terminal for a group of battery cells.

A group of a predetermined number of anodes and cathodes are assembled in a suitable close-fitting container which is then filled with the electrolyte solution as the container is being closed. The electrolyte is inserted into the assembly of alternating opposing electrodes so as to suitably infiltrate and fill the pores of each layer of electrode material such that substantially each particle of electrode material is contacted and wetted by the electrolyte solution with its predetermined concentration of lithium ions. Typically, only the respective terminals extend outside the finished and closed package of assembled cell units.

But the terminals are used in delivering direct current to the electrical power consuming devices connected to the battery and to receive electrical current for recharging the battery. And the terminals are also used for connections to controls, instrumentation and computer data storage and processing for several functions, including assessing the state of charge (SOC) of the battery and for initiating re-charging of the cells of the battery.

The following discussion pertains to management of the operation of a lithium battery formed of lithium-ion cells in which the anode material is based on micrometer-size particles of graphite. At some stage in the preparation of each anode it is necessary to intercalate the particles of carbon with lithium. And a like practice is involved each time a lithium-depleted anode (following each cell discharge cycle) is re-charged by the application of a suitable reverse voltage between the cathode (now a minus DC charge) and the anode (now a plus DC charge) for the purpose of re-intercalation of lithium into each graphite particle (or other suitable anode material) of the porous anode material layer.

During charging of the lithium cell, lithium ions are intercalated from the surrounding liquid electrolyte onto the surfaces of the small layered graphite particles of the anode material. In graphite, the carbon atoms are arranged in layers, in which each carbon atom is bonded to three others by single or double covalent bonds. The lithium ions encounter electrons entering the graphite particles of the anode from the flow of charging current and react with the carbon (graphite) particles to form an intercalation compound per the following equation:

xLi⁺+xe⁻+C₆→LiₓC₆(0≤x≤1)

Thus, six carbon atoms of the graphite crystal structure can accommodate up to one lithium atom in the intercalation process, driven by the applied charging potential. By this process, the initial anode material of graphite particles is filled with (accommodates) lithium atoms at the existing reaction rate established by the environmental conditions at the anode site. And after an operating cell is substantially discharged by the depletion of the lithium content of the anode, by transferring it to the cathode, the lithium content is restored in the graphite particles by a like re-charging process.

However, during operating battery recharging processes, depending on the rate of charging, it is sometimes found that not all the lithium entering the anode material is accommodated into the graphite particles in the LiC₆ intercalation form. Sometimes, lithium metal is simply plated on the surfaces of the graphite particles. Some lithium ions collect an electron and simply form plated lithium metal. This is an undesirable result of the charging process. The plated lithium metal does not function in the anode material in the same manner as the lithium content of the LiC₆ composition. The plated lithium metal reduces the electrical capacity of the cell and has its own electrochemical voltage potential which also interferes with the basic function of the lithium-ion battery cell. Further, some of the plated lithium tends to react with the electrolyte to yield an inert product containing lithium, and that reacted lithium product is no longer available to function in the cell. The cell loses a small amount of capacity and, over time, this can lead to early cell failure. If a lot of lithium is plated, the reactions with the electrolyte solvent can be severe, including a rapid thermal event. And the plated lithium can form a dendrite extending from the anode and electrically shorting the cell.

In accordance with practices of this invention, the re-charging process is managed so as to improve the rate and the efficiency of the intercalation of lithium back into the anode graphite particles, with the lithium being present in the LiC₆ composition.

In accordance with research work leading to this disclosure, it was observed that the charging rate of the graphite with lithium ions can lead to the following scenarios. Lithium fills the host graphitic carbon in accordance with the above reaction equation by forming LiC₆. But the rate of lithium addition (i.e., transfer from the electrolyte solution) to the surfaces of the graphite particles may exceed the rate of lithium incorporation into the graphite crystal structure as LiC₆. As the charging process continues, lithium metal saturates the available surface sites of the graphite particles and then accumulates on the surfaces of the particles. Upon cessation of the charging current, the lithium may slowly diffuse into the graphite particles. But with the presence of the plated lithium, the negative electrode potential has been altered. The negative electrode potential is temporarily (at least) closer to that of a lithium metal anode than to its intended higher potential of the LiC₆ anode material. It is found that as the lithium gradually diffuses into the graphite material, forming LiC₆, the potential of the anode gradually rises to its intended level as if no lithium had plated. It is found that the anode potential continues to relax to an equilibrium value as the concentration profile of plated lithium metal on the graphite particles continues to diminish or vanish after a period of time.

But in an assembly of battery cells intended, for example, to power an electric motor to drive the wheels of a vehicle, the presence of plated lithium metal on the graphite anode particles, even if temporary, is undesirable. The battery may be placed in its operational discharge mode while the plated lithium is still present and the function of the battery cells is compromised. It is important in the operation of a battery in such a working environment that the re-charging process, often rapid, be monitored and managed to minimize the plating of lithium (or any like metal in a battery cell anode) during the critical re-charging cycle of battery operation.

Thus, in accordance with practices of this invention, the charging of the battery is monitored, such as under the control of a suitably programmed computer in the vehicle or in another device having a motor or other like load-bearing machine. In this example, the battery will be formed of an anode, or group of anodes formed of graphite particles as the active anode material. And the cathode material and liquid electrolyte will be compatible with the graphite anode material. The applied charging current is controlled at varying levels; such as charging levels above, at, or below a 1 C charging level for the battery cell(s). The charging current will be continually measured and the data delivered to the programmed computer, commonly at a rate of 0.1 second per current-potential-time data point. And the voltage potential of the anode with respect to the cathode (V_{cell}) will be measured and the data transmitted to the programmed computer. The voltage potential will be measured during the charging of the anode cell(s) and during open-circuit periods immediately following charging periods. In addition, the voltage potential of the anode (negative electrode, V_{neg}) The programmed computer associated with the management of the charging process will also be programmed to calculate the derivatives of the change in voltage of the cell (V_{cell}) with time (t, in seconds) during open-circuit periods following a charge period (dV_{cell}/dt), and to calculate the derivatives of the change in voltage of the anode (negative electrode) vs. a lithium reference electrode (V_{neg}) with time (t, in seconds) following a charge period (dV_{neg}/dt).

In accordance with a preferred practice of this disclosure, the derivative of cell voltage with time is based on a computer-based analysis of the open-circuit data and a suitable fitting of the V versus time data to a polynomial, such as Vᵢ=a+bt+ct²+dt³. The derivative, dVcell/dt is then equal to values of b+2ct+3dt².

Monitoring and management of the charge process for the graphite anode(s) proceeds as follows. The operator of a vehicle using a battery for at least part-time powering of an electric-drive motor may initiate a charge cycle when the vehicle is idle. Or the vehicle may have on-board charging means such as an engine-powered generator and/or means associated with vehicle braking. When the programmed computer determines that recharging of the battery is available or appropriate, a charging cycle is initiated at a charging level based on a predetermined value of C (amperes per hour), where C is a predetermined current charge level that will fully re-charge a discharged cell, of known electrode materials and amounts, in one hour. The determined charging rate is usually based on a multiple of C, for example 0.4 C or 1.4 C. The applied charging level may be based on the computer-stored experience of previous charging cycles of the battery.

During the charging, the computer may be tracking and storing the cell potential (V). Following a predetermined period of charging at the initial charging rate, the charging is ceased, with the cell or battery in an open-circuit mode. During the open-circuit stage, the derivative of the cubic fit of the cell voltage with elapsed time (dVcell/dt) over a predetermined period of seconds is determined and stored. Alternatively, or in combination, the derivative of the negative electrode potential vs. Li (dV_{neg}/dt) is determined and stored in the programmed computer. This data is obtained at a measured ambient temperature when the vehicle is not operating, or at a measured temperature in the moving vehicle. If a bump or discontinuity (abrupt change in direction of the calculated derivative data) in the derivative curve is found, it is attributed to un-wanted plating of lithium metal on the graphite particles of the anode as it is being charged. The charging process is either stopped for a pre-determined period to allow the plated lithium to be reacted with the graphite or is re-started at a lower charge rate (C) selected to better balance the rate of deposition of the lithium onto the graphite particles with the rate of assimilation of the lithium into the graphite material as LiC₆.

Thus, in accordance with practices of this invention, a future charge rate of the graphite cell(s) of a lithium-ion battery is determined based on open-cell voltage with time data, suitably fitted to a cubic polynomial of Vᵢ as a function of tᵢ. The derivative of either dV_{cell}/dt or dV_{neg}/dt is then obtained. The presence or absence of a local minimum (a bump-like discontinuity) in the derivative curve of dV_{cell}/dt or dV_{neg}/dt indicates whether the present charge rate is appropriate or suitable. As will be discussed and described in more detail below in this specification, the presence of such a discontinuity in the cell potential is a timely indication of the presence of lithium on the surfaces of the graphite particles of the anode of the cell(s). This selected derivative data indicates that the rate of deposition of lithium from the cell electrolyte onto the surface of the graphite particles is greater than the rate at which the lithium is being assimilated as LiC₆ in the anode material.

Practices of methods of this invention will be described in more detail in the following sections of this specification. Reference will be made to the drawings which are described in the following section of this specification.

### BRIEF DESCRIPTION OF THE DRAWINGS

FIG. 1 is a graph of open-circuit cell potentials, in volts (V) versus time, in seconds (s), following charging at 25° C. of five different identical lithium-ion battery cells with graphite anodes. The cells were charged to fractional state-of-charge levels (SOC), respectively, of 0.60, 0.65, 0.70, 0.75, and 0.80. The open cell potentials with time are respectively 0.80, solid line; 0.75, dash dot line; 0.70, long dash line; 0.65, medium dash line; and 0.60, shortest dash line. The dotted curve lying with the solid line curve represents fitted data points forming a cubic polynomial curve with respect to the 0.80 data.

The graph covers a period of about 1800 seconds following the termination of cell re-charging. In each example, the cell potentials decrease from the respective re-charge potentials of about 3.9 to about 4.1 volts. The respective open-circuit cell potentials decrease over a period of about 500 seconds and level off to generally steady potential values.

FIG. 2 is a graph of the differentials of the respective open-circuit values of the cells of FIG. 1 with time, d(cell potential)/dt, V/s. As will be explained in detail below in this specification, the values of the differentials were obtained using a cubic fit of the data of the five cells presented in FIG. 1. The differentials of the open cell potentials with time are respectively for 0.60, solid line; 0.65, dash dot line; 0.70, long dash line; 0.75, medium dash line; and 0.80, shortest dash line. The differential data is presented from about 200 seconds following open-circuit status.

The differential values for the cells charged to SOCs of 0.60, 0.65, 0.70 increase smoothly with time towards values of zero. These curves indicate that no lithium plating occurred during the charging of these cells. The differential values for the cells charged to SOCs at 0.75 and 0.80 initially decrease and then increase with time toward values of zero (displaying a minimum), indicating the lithium plating has occurred during the charging of these cells at the higher rate of charge.

### DETAILED DESCRIPTION

Lithium-ion batteries made for automotive applications may be characterized as modules that contain a plurality of individual cells, each cell, for example, comprising a graphite anode(s), negatively-charged during cell discharge, separated from a lithium compound cathode(s), positively-charged and contained in a polymer coated, metal foil-type battery pouch. Each cell has positive and negative extensions for serial or parallel electrical connections with other cells in a larger battery pack that is sized for a specific application based on its power requirements.

A battery management systems (BMS) may be used as an electronic controller in conjunction with a battery module or a group of battery modules. The BMS may include one or more computer devices, each having a processor and sufficient amounts of memory, for example, read only memory, random access memory, and electrically-erasable programmable read-only memory. Such computing devices are commercially available and used in the management of the operation of lithium-ion battery modules, including the charging and discharging of the cell modules. And such a battery management system may be used in the subject methods of determining whether a specific charge-rate is causing the plating of lithium onto graphite particles in a lithium-ion battery cell.

Following a charge cycle of a lithium battery in which the vehicle is not currently being driven, the battery is permitted to stand idle, preferably for a period of several minutes, suitably up to about thirty minutes. During this period open-circuit voltage data is continually obtained using a voltage sensing device of the BMS at specified intervals of time (e.g., each 0.1 second interval) and the successive values of voltage (Vᵢ) and time in 0.1 second intervals (sᵢ) are recorded and stored in the voltage recording member of the BMS or like computational device.

By way of illustrative example, five, substantially identical, lithium battery cells were prepared as follows.

The cells were obtained by taking apart cell groups produced for use in Chevrolet® Bolt® electric vehicles. In these cells the positive electrode active material is Li(Ni_{0.6}Mn_{0.2}Co_{0.2})O₂ (NMC622) and the negative electrode material is graphite. The cells are representative of those used in commercial, electric-motor driven automotive vehicles.

The anode and cathode, separated by two porous, inert polyethylene separators, each about fifteen microns in thickness, were placed in a fixture and immersed in a LiPF₆ electrolyte solution (1M, ethylene carbonate/diethylene carbonate). A lithium wire reference electrode was placed between the PE separators. The charging and open-circuit testing of the five cells was done in an argon-filled glove box. Similar results are obtained using semi-graphite negative electrodes, such as carbon coke and hard carbons which reversibly store and release lithium.

Each of the five cells was charged at a rate of 0.85 C to its respective end-of-charge, state of charge values (SOC), respectively of 60, 65, 70, 75, and 80.

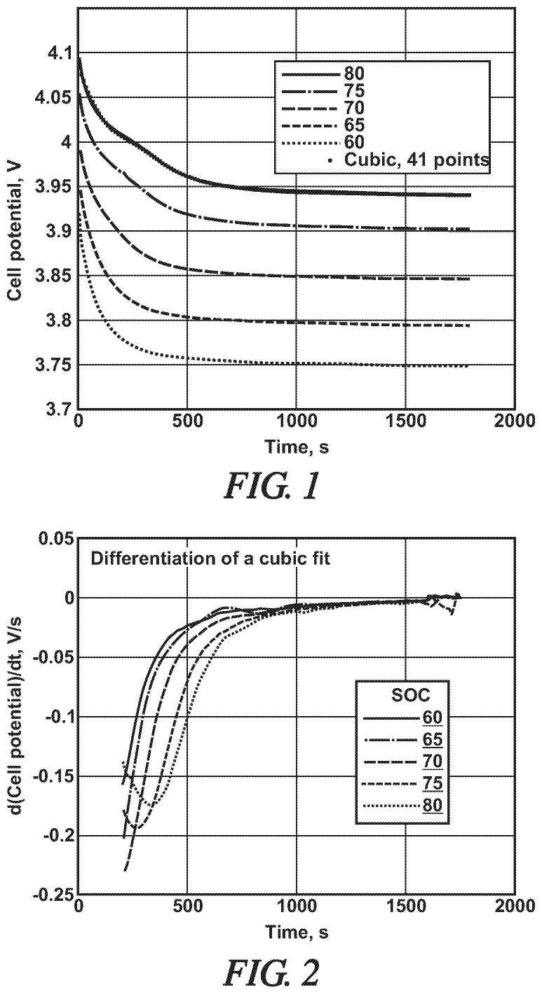

Each cell was then allowed to stand at room temperature for a period of about thirty minutes and its open-circuit voltages were measured. Voltage values were taken each ten second period and recorded in the memory of a computer. The data is plotted in FIG. 1 for the respective cells. The dotted line following the solid line for the 80 end of charge value is from the cubit fit to the observed data.

The smooth curves presented in FIG. 1 do not present any indication of lithium plating in the graphite anodes of the respective cells. However, it is found that such information can be obtained from a differential analysis of the open-circuit cell voltage vs. time data. It is found that data obtained from the following differential analysis, with respect to lithium plating on a graphite anode, corresponds to information obtained by physical examination of the electrode.

In accordance with preferred practices of this disclosure, a cubic polynomial fit of the voltage/time data is used for this purpose. Lower and higher polynomial fits (linear, quadratic, and fourth power) may be used. But a cubic fit of the data is preferred.

That is, the recorded voltage vs. time data is analyzed and processed to a cubic fit: V=a+bt+ct²+dt³.

The cubic fit of the data is then used to obtain the differential data: dV/dt=b+2ct+3t² from the voltage v. time data. It is found that when the differential data is plotted as illustrated in FIG. 2, the presence of a local minimum in the differential data (for example, a decrease in the differential value followed by an increase) indicated the presence of observable lithium plating on the graphite anode material.

The recorded voltage measurements were obtained using a volt-meter. This volt-measuring member may have a sigma value (σ), i.e., a standard deviation in the measurement, provided by the manufacturer or determined by routine test procedures on many samples (e.g., 30 or more independent measurements on the same sample). For example, a representative sigma value for the voltage measuring device may lie in the range of about 0.05 mV to about 20 mV. This information is used in the handling of the measured and recorded voltage data.

An analysis of the recorded open-circuit voltage-with-time data is made. A single standard deviation in the collected the open-circuit voltage data σ_{data} is determined. This sigma value is used to determine a suitable number (N) of consecutive voltage values (Vᵢ) at specified times (tᵢ) that should be used to fit the coefficient values (a, b, c, and d) in the above cubic polynomial. Preferably an odd value of N is determined (for example, N=41) so that (N−1)/2 data points on each side of a selected data point Nᵢ is used in determining the data point.

A variance σ is computed between the fit and data points, except for (N−1)/2 data points at the start and end of the time series. This gives N_{T} data points that are fit:

$$σ = \sqrt{\frac{1}{{N}_{T}} {\sum }_{i = 1}^{{N}_{T}} {( {V}_{i} - {\overline{V}}_{i} )}^{2}}$$

where Vᵢ (bar)=aᵢ+bᵢ(t−tᵢ)+cᵢ(t−tᵢ)²+di(t−tᵢ)³ is the fit of the data, and a subscript i refers to time tᵢ and to Vᵢ at time tᵢ. At times t=tᵢ, Vᵢ(bar)=aᵢ and dVᵢ (bar)/dt=bᵢ. The values obtained for aᵢ, bᵢ, cᵢ, and dᵢ will depend on the data window size N. Hence, aᵢ is a function on N, aᵢ(N).

The number of voltage data points in the window N are chosen such that the variance σ is equal to σ_{data}. Thus, the following nonlinear equation may be used to solve for window size N:

$$1 - \frac{1}{{N}_{T} {σ}_{data}^{2}} {\sum }_{i = 1}^{{N}_{T}} {[ {V}_{i} - {a}_{i} ( N ) ]}^{2} = 0.$$

In the data used in producing the graphs of FIG. 1, it was found that when N had a value of 41 voltage data points, the fit of the cubic polynomial yielded a variance, σ, which equaled 0.47 mV. This value was consistent with the variance in the data points of the V versus time curves of FIG. 1 for the five test cells.

Accordingly, when a suitable number of data points N is determined for the fit of coefficient values in cubic polynomial of V=aᵢ+bᵢ(t−tᵢ)+cᵢ(t−tᵢ)²+dᵢ(t−tᵢ)³ and its differential dV/dt=bᵢ+2cᵢ(t−tᵢ)+3dᵢ(t−tᵢ)², the BMS (or other suitable calculating device is used to plot the differential curves of FIG. 2: d(cell potential)/dT, V/s.

As an alternative approach to a suitable determination of dV/dt, a cubic smoothing spline may be used. Again, the use of a cubic polynomial is preferred. As with the cubic fit, a cubic smoothing spline of the form

V(bar)(t)=aᵢ+bᵢ(t−tᵢ)+cᵢ(t−tᵢ)²+dᵢ(t−tᵢ)³,tᵢ≤t≤tᵢ₊₁

where V(bar) is the fit to V. At times tᵢ, Vi(bar)=ai and dV(bar)/dtᵢ=bᵢ.

A smoothing parameter p is used to penalize curvature in the regression in accordance with (C. de Boor, A Practical Guide to Splines, revised edition, Springer, 2001. See chapter 14 for smoothing splines. And, D. S. G. Pollock, A Handbook of Time-Series Analysis, Signal Processing and Dynamics, Academic Press, 1999. See chapter 11 for smoothing splines.):

$$P = p {\sum }_{i = 1}^{N} {( {y}_{i} - {a}_{i} )}^{2} + ( 1 - p ) {\int }_{{x}_{1}}^{{x}_{N}} {[ {f}^{″} ( x ) ]}^{2} dx$$

The function P is minimized. The integration of the square of the second derivative f″(x) of the function f(x) represents the accumulation of the squares of all local curvatures from x₁ to x_{N}. As p nears 1, no smoothing results, and we obtain an interpolating polynomial, wherein the regression passes through each point. As p nears 0, smoothing is complete, no local curvature is allowed, and we obtain a least-squares linear regression of the data.

As was done for the windowed cubic polynomial, the smoothing parameter p may be obtained from

$$1 - \frac{1}{{N}_{T} {σ}_{data}^{2}} {\sum }_{i = 1}^{{N}_{T}} {[ {V}_{i} - {a}_{i} ( N ) ]}^{2} = 0$$

All fit polynomial coefficients of the smoothing spline, including aᵢ and bᵢ, are dependent on the value of the smoothing parameter p. For the smoothing spline, N_{T} corresponds to all of the data—there are no end effects as there are for the windowed cubic polynomial.

It is these differential curves, based on suitably fitting the stored open-circuit voltage v. time data to a cubic polynomial that enables a rapid and suitable accurate analysis of the presence of lithium plating in a rapid managed battery charge process.

The differential curves, d(cell potential)/dt, V/s, thus calculated and presented in FIG. 2, present data has been determined to be related to the existence of lithium plating on the graphite anode materials of the five evaluated cells. It is found and corroborated the cells at SOC values of 60, 65, and 70 presented no physical evidence of lithium metal plating in their graphite anode material. And the differential curves for these cells as presented in FIG. 2 display generally smooth decreasing values toward zero. But the differential curves, for the cells with initial, as-charged SOC values of 75 and 80, initially decreased, reached a minimum value, and then increased with lower negative values. These cells were examined and found to have evidence of unwanted plating of lithium on their graphite anode material.

Following is a discussion of on-vehicle practices that can be used to monitor the charging of a lithium ion cell with a graphite anode so as to find a maximum charge rate that minimizes the formation and retention of lithium plated on the anode material.

In many situations, a vehicle lithium-ion battery pack will be charged when the vehicle is not being driven. It may be parked in a garage or near another suitable power source for the charging operation. And many such lithium cells utilize graphite anodes (e.g. 288 cells and anodes). A present-day vehicle containing a battery pack sized to power an electric vehicle-driving motor also contains computer capacity and supporting instrumentation to manage the cyclical discharging and re-charging of the vehicle battery. The on-vehicle computer-based battery control system (or battery management system, BMS) and associated instrumentation contain stored values for the state-of-charge of the battery pack and contain reference data from previous charging periods for the on-vehicle battery pack. Such existing on-board equipment may be utilized and expanded as necessary to manage lithium ion battery packs with graphite anodes so as to minimize the plating of lithium onto the graphite particles.

The battery charging program of the vehicle/battery control system will have data concerning the present state of charge (SOC) of the graphite anodes-based battery pack as well as its present temperature, T (e.g., in degrees C.). The present open-circuit voltage (ocv, V) of the battery pack or of a representative cell is also available and stored in the computer. This data set (SOC, T, ocv) may be used as a first charging calibration parameter, cal_a, for recharging graphite anodes with lithium ions in the form of the LiC₆ composition.

Based on the values of the constituents of the calibration, cal_a, the on-vehicle computer is programmed to utilize a stored value (from a look-up table) to set a total charge current value (cal_i) for the charging of the battery pack. The charging program of the on-vehicle computer also has a stored value of a suitable maximum battery pack voltage based on the temperature of the cell, calibration (cal_v: Vₘₐₓ(T)).

As the charging of the battery pack proceeds, the total charge current is measured, and SOC and temperature values are updated in the computer storage. The maximum battery pack voltage at the temperature (cal_v, Vₘₐₓ(T)) provides a boundary for the duration and termination of the charge period. At this stage, the charging process is stopped and open circuit values of the cell (Vcell) with time (in seconds or less) and/or the potential of the negative (anode) electrode vs. a lithium metal reference electrode (V_{neg}) are measured during the open-circuit period immediately following the charge period.

As stated above in this specification, the charging of a lithium ion battery results in lithium being intercalated into the active anode material. In many such batteries, the active anode material comprises particles of graphite. In order to properly charge the cell, the lithium must be suitably reacted with and assimilated into the graphite as LiC₆. If the charging rate is too fast, some of the lithium is not assimilated as LiC₆, it is plated as lithium metal on the graphite particles. Prior to this work there was no known process for determining whether lithium plating is occurring during the charging process. In some instances, some of the plated lithium metal gradually reacts with the graphite to form LiC₆, but, as described above in this specification, any remaining plated lithium metal is detrimental to the continuing operation of the cell(s).

Practices of this disclosure make use of our observation that plated lithium metal on the anode graphite-LiC₆ material acts like a competing anode material and affects the cell potential (V_{cell}). And if the graphite anode material is connected with a reference electrode of lithium metal, the lithium-plating affects the potential between the anode (negative electrode) and the reference electrode (V_{neg}). But, during the open-circuit period following the charging process, the presence of plated lithium may be detected by examination of a plot, or accumulated stored values, of dV_{cell}/dt and/or of dV_{neg}/dt, each in mV/s. It is observed that if these derivative values, of the specified potentials with time, present themselves as a bump or a minima in dV_{cell}/dt or a maxima in dV_{neg}/dt in the derivative curves, such a minima or maxima is evidence of the presence of unwanted plated lithium, incorporated with the LiC₆-containing graphite. Such data and minima in the derivative curves are presented in FIG. 2 of this specification.

In accordance with practices of this disclosure, it is preferred that the derivative curve(s) be based on a cubic polynomial, suitably prepared from the open-circuit voltage-time data. The derivative data is derived from the cubic polynomial data as described above in this specification. A discontinuity in the cubic polynomial data is found to be a very reliable indication of the presence of lithium plating on graphite anode material.

Such discontinuities in the derivative curves typically occur within a period of one to twenty minutes, or so, at the beginning of the open-circuit period. This information, obtained from the derivative curves, may be suitably used in a following battery charging period.

Thus, at the completion of a charging period and at the beginning of an immediately-following open circuit period, the computer-managed charging system monitors dV_{cell}/dt and/or dV_{neg}/dt in mV/s based on the cubic polynomial data of the open-circuit voltage data. If no local minimum is found in dV_{cell}/dt or no local maximum is found in dV_{neg}/dt within a predetermined period of open-circuit voltage e.g., calibration parameter cal_b, specified above in this specification, then it may be concluded that no lithium plating has occurred during the previous charging cycle. If there is no evidence of a discontinuity in the derivative curve, a subsequent battery charging program may be conducted at the same charging parameters (cal_i and cal_v) or, possibly somewhat faster charging parameters.

But if a local minimum is found in dV_{cell}/dt and/or a local maximum is found in dV_{neg}/dt within a predetermined period of open-circuit voltage e.g., calibration parameter cal_b, then it is necessary to reduce I_{charge} (T,SOC) for the next charge event by reducing the charging current (cal_i) and/or the charging potential (cal_v).

The practice of assessing dV_{cell}/dt and/or dV_{neg}/dt may be performed after a full charging period using previous charging monitoring data. And the gathered derivative-based data may be used by the computer monitoring system, as described, to set the charging calibrations for the next charging period following a substantial period of battery use in powering the vehicle or other device in which it is used. Alternatively, a generally full charging cycle may be interrupted from time-to-time for the purpose of checking for lithium plating and then modifying the charging parameters as necessary to minimize lithium plating while also promoting the rate at which the charging of the battery is accomplished.

As demonstrated, a value of this invention is to provide a monitoring system, associated with the charging of a substantial and large battery system so as to detect and minimize lithium plating onto graphite anode material. While many such systems are used on automotive vehicles, they are also used with other power-consuming devices.

The practice of monitoring lithium plating may also be performed during or after regenerative braking or like on-vehicle charging events. Thus, the practice may also be conducted during low current charge events (e.g. 0.1 C events. Such low charge events are considered as equivalent to open-circuit periods in practices of this invention.

And while the practice of the subject monitoring process, using derivatives of voltage potentials with time, has been demonstrated with respect to the intercalation of lithium into graphite anodes, the monitoring process is likewise applicable to processes of intercalating magnesium and/or sodium into graphite particles for electrodes or other applications. Also, the monitoring process is applicable to the intercalation of these metals (lithium, magnesium, or sodium) into silicon-graphite anodes.

1. A method of monitoring the intercalation of lithium into particles of graphite in the anode of a lithium-ion battery cell during charging of the battery cell, the lithium battery cell also comprising a cathode, separated from the anode, and a lithium ion-containing electrolyte in contact with the graphite particles of the anode and with the cathode, the battery cell optionally having a reference electrode of lithium metal, the charging of the lithium-ion battery cell being accomplished by the application of (i) a specified voltage potential applied to the anode and cathode and (ii) a specified total charging current, carrying lithium ions to the graphite particles for the purpose of incorporating lithium into the graphitic carbon as LiC₆, the purpose of the monitoring method being to detect the unwanted plating of metallic lithium on the graphite particles rather than the formation of LiC₆, the monitoring method comprising:
maintaining the battery cell in an open-circuit state for a specified time period following the charging of the battery cell; and during the time period,
measuring the open-circuit cell voltage (V_{cell}) at predetermined periods of time;
determining a cubic polynomial fit of the open-circuit voltage data with time values during the time period, with the square root of the sum of the squared difference between the fit polynomial and the data, normalized by the number of data points, set equal to the standard deviation in the voltage measurement process, allowing for the appropriate selection of the window size of data to be included for a windowed polynomial regression or the smoothing parameter in a smoothing spline regression;
determining the derivative of the cubic polynomial fit of the open-circuit cell voltage with time (dVcell/dt, mV/s);
examining the derivative data collected over the specified time period to determine whether the data presents a smooth curve or a curve with a local maximum or minimum, a smooth curve indicating the absence of lithium plating, a curve with a local maximum or minimum indicating the presence of lithium plating; and, thereafter,
using the derivative data in determining the specified voltage potential or the total charging current for a subsequent intercalation of lithium into the graphite anode material.

2. A method of monitoring the intercalation of lithium into particles of graphite in the anode of a lithium-ion battery cell during charging of the battery cell as stated in claim 1 in which a number of voltage/time data points are selected to obtain a suitable fit of the voltage/time values to obtain a cubic polynomial fit with the voltage/time data values and using the cubic polynomial fit to obtain the derivative of the cubic polynomial fit.

3. A method of monitoring the intercalation of lithium into particles of graphite in the anode of a lithium-ion battery cell during charging of the battery cell as stated in claim 1 in which the battery charging process and monitoring process are conducted under the control of a programmed computing device connected with the battery.

4. A method of monitoring the intercalation of lithium into particles of graphite in the anode of a lithium-ion battery cell during charging of the battery cell as stated in claim 1 in which the derivative data is calculated based on open-circuit voltage obtained during the first one to twenty minutes of an open-circuit period.

5. A method of monitoring the intercalation of lithium into particles of graphite in the anode of a lithium-ion battery cell during charging of the battery cell as stated in claim 1 in which the derivative data presents a smooth curve and the subsequent charging process is conducted at the same charging conditions.

6. A method of monitoring the intercalation of lithium into particles of graphite in the anode of a lithium-ion battery cell during charging of the battery cell as stated in claim 1 in which the derivative data presents a smooth curve and the subsequent charging process is conducted at more aggressive charging conditions.

7. A method of monitoring the intercalation of lithium into particles of graphite in the anode of a lithium-ion battery cell during charging of the battery cell as stated in claim 1 in which the derivative data presents a curve with a local maximum or minimum indicating the presence of lithium plating and the subsequent charging process is conducted at less aggressive charging conditions.

8. A method of monitoring the intercalation of lithium into particles of graphite in the anode of a lithium-ion battery cell during charging of the battery cell as stated in claim 1 in which the open circuit voltage of the anode vs. the reference electrode is measured (V_{anode}) and the derivative values of a cubic polynomial fit, dV_{anode}/dt, are determined and used to determine the specified voltage potential or the total charging current for a subsequent intercalation of lithium into the graphite anode material.

9. A method of charging a lithium-ion battery cell which comprises (i) a first electrode formed of a porous layer of particles of graphite, the first electrode functioning as a negatively-charged anode during discharge of the battery cell, at least a portion of the particles of graphite being characterized by the presence of LiC₆ when the battery cell is in a charged state, the graphite particles being depleted of LiC₆ as the battery cell is being discharged, (ii) a second electrode physically separated from the first electrode and being formed of an electrode material electrochemically compatible with the graphite particles, the second electrode functioning as a cathode during discharge of the battery cell and (iii) an electrolyte solution comprising mobile lithium ions, the electrolyte solution being in contact with both electrodes, the charging method comprising:
applying a predetermined direct current charging-potential for a predetermined period of time between the first and second electrodes so as to direct lithium ions in the electrolyte solution into contact with the graphite particles of the first electrode for the purpose of reacting lithium ions with electrons on the graphite particles and forming LiC₆ in the graphite particles;
terminating the charging current and placing the lithium-ion battery cell in an open-circuit state;
measuring, over a first predetermined period of time (t, in seconds) of the open-circuit state, at least one of (i) the open-circuit cell voltage (V_{cell}) and (ii) the voltage of the negative electrode vs. a lithium metal reference electrode (V_{neg}) to obtain a voltage curve vs. time for V_{cell} or V_{neg};
determining a cubic polynomial fit of the open-circuit voltage data with time values during the time period, with the square root of the sum of the squared difference between the fit polynomial and the data, normalized by the number of data points, set equal to the standard deviation in the voltage measurement process, allowing for the appropriate selection of the window size of data to be included for a windowed polynomial regression or the smoothing parameter in a smoothing spline regression;
preparing a derivative curve of the cubic polynomial fit for dV_{cell}/dt or dV_{neg}/dt;
examining the derivative data collected over the specified time period to determine whether the data presents a smooth curve or a curve with a local maximum or minimum, the smooth curve indicating the absence of lithium plating, a curve with a local maximum or minimum indicating the presence of lithium plating; and, thereafter,
using the derivative data in determining the specified voltage potential or the total charging current for a subsequent of the graphite anode material.

10. A method of monitoring the intercalation of lithium into particles of graphite in the anode of a lithium-ion battery cell during charging of the battery cell as stated in claim 9 in which a number of voltage/time data points are selected to obtain a suitable fit of the voltage/time values to obtain a cubic polynomial fit with the voltage/time data values and using the cubic polynomial fit to obtain the derivative of the cubic polynomial fit.

11. A method of monitoring the intercalation of lithium into particles of graphite in the anode of a lithium-ion battery cell during charging of the battery cell as stated in claim 9 in which the battery charging process and monitoring process are conducted under the control of a programmed computing device connected with the battery.

12. A method of charging a lithium-ion battery cell as stated in claim 9 in which the derivative data is collected and analyzed during an open circuit state period of one to twenty minutes.

13. A method of charging a lithium-ion battery cell as stated in claim 9 in which the derivative data for dV_{cell}/dt presents a smooth curve and the subsequent charging process is conducted at the same charging conditions.

14. A method of charging a lithium-ion battery cell as stated in claim 9 in which the derivative data for dV_{cell}/dt presents a smooth curve and the subsequent charging process is conducted at more aggressive charging conditions.

15. A method of charging a lithium-ion battery cell as stated in claim 9 in which the derivative data for dV_{cell}/dt presents a curve with a local maximum or minimum indicating the presence of lithium plating and the subsequent charging process is conducted at less aggressive charging conditions.

16. A method of charging a lithium-ion battery cell as stated in claim 9 in which the derivative data for dV_{neg}/dt presents a smooth curve and the subsequent charging process is conducted at the same charging conditions.

17. A method of charging a lithium-ion battery cell as stated in claim 9 in which the derivative data for dV_{neg}/dt presents a smooth curve and the subsequent charging process is conducted at more aggressive charging conditions.

18. A method of charging a lithium-ion battery cell as stated in claim 9 in which the derivative data for dV_{neg}/dt presents a curve with a local maximum or minimum indicating the presence of lithium plating and the subsequent charging process is conducted at less aggressive charging conditions.

19. A method of monitoring the intercalation of a metal into particles of graphite or of graphite and silicon in the anode of a battery cell during charging of the battery cell, the metal being one selected from the group consisting of lithium, magnesium, and sodium, the battery cell also comprising a cathode, separated from the anode, and a metal ion-containing electrolyte in contact with the graphite or graphite-silicon particles of the anode and with the cathode, the charging of the battery cell being accomplished by the application of (i) a specified voltage potential applied to the anode and cathode and (ii) a specified total charging current, carrying metal ions to the graphite or graphite-silicon particles for the purpose of incorporating the metal into the graphite or graphite silicon particles, the purpose of the monitoring method being to detect the unwanted plating of the metal on the anode particles, the monitoring method comprising:
maintaining the battery cell in an open-circuit state for a specified time period following the charging of the battery cell; and during the time period,
measuring the open-circuit cell voltage (V_{cell}) at predetermined periods of time;
determining a cubic polynomial fit of the open-circuit voltage data with time values during the time period;
determining the derivative of the cubic polynomial fit of the open-circuit cell voltage with time (dVcell/dt, mV/s);
examining the derivative data collected over the specified time period to determine whether the data presents a smooth curve or a curve with a local maximum or minimum, the smooth curve indicating the absence of metal plating, a curve with a local maximum or minimum indicating the presence of metal plating; and, thereafter,
using the derivative data in determining the specified voltage potential or the total charging current for a subsequent intercalation of the metal into the graphite or graphite-silicon particles of anode material.

20. A method of monitoring the intercalation of a metal into particles of graphite or of graphite and silicon in the anode of a battery cell during charging of the battery cell as stated in claim 19 in which the derivative data is collected and analyzed during the first one to twenty minutes of an open-circuit period.
